(19) United States
(12) Patent Application Publication
(10) Pub. No.: US 2021/0042676 A1
(43) Pub. Date: Feb. 11, 2021

(54) SYSTEM FOR COMMUNICATING BETWEEN ASSETS ON A CONSTRUCTION SITE AND A DATABASE SERVER

(71) Applicants: Barry J. Nield, Jacksonville Beach, FL (US); George A. Nield, Jacksonville Beach, FL (US)

(72) Inventors: Barry J. Nield, Jacksonville Beach, FL (US); George A. Nield, Jacksonville Beach, FL (US)

(21) Appl. No.: 16/537,608

(22) Filed: Aug. 11, 2019

(51) Int. Cl. G06Q 10/06; G06F 16/25

(52) U.S. Cl. CPC G06Q 10/06313; G06F 16/258; G06F 16/252

(57) ABSTRACT

A system for communicating between assets associated with a construction site and a database server remote from the construction includes a data acquisition board on the construction site. A plurality of sensors each associated with an asset on the construction site transmits data associated with its respective asset to the data acquisition board. A processor in communication with the data acquisition board is configured to execute a first logic that causes the processor to receive the data from each sensor within a project area defined by a predetermined distance from a predefined reference point or a predetermined list, format said received data, and transfer the received data to the database server.

### FIELD OF THE INVENTION

The present invention generally involves a system and method for communicating with, and between, assets on a Construction site and a remote database server or personal device. In particular embodiments, the system and method may be incorporated into land-based or offshore construction sites for locating assets, allocating assets, grouping assets, and monitoring assets.

### BACKGROUND OF THE INVENTION

A construction site or building site is an area or piece of land on which construction works are being carried out and refers to all types of works. Typically, a section of land will become a construction site when it is handed over to a contractor to begin the construction works. Construction works include site clearance, setting up site facilities, demolition, groundworks, and so on. Such activities require lots of equipment and heavy machinery. Heavy construction equipment is used for various purposes at construction sites and can include excavators, backhoes, dragline excavators, bulldozers, graders, trenchers, loaders, cranes, pavers, dump trucks, pile boring machine, and pile driving machine. There is a need to efficiently manage all the equipment on a construction site during current and future projects. Such management need requires a system for communicating with and monitoring the various equipment on the construction site.

The disclosed apparatus and method provide for a system and method for communicating with equipment associated with a construction site that detects, identifies, monitors, and controls the equipment on the construction site.

### BRIEF DESCRIPTION OF THE INVENTION

Aspects and advantages of the invention are set forth below in the following description, or may be obvious from the description, or may be learned through practice of the invention.

One embodiment of the present invention is configured for communicating between a plurality of assets associated with a construction site and a database server remote from the construction site. The system includes a data acquisition board on the construction site. A plurality of sensors are each associated with an asset on the construction site, and each sensor transmits data comprising asset identification information and an operating parameter of its respective asset to the data acquisition board. A processor in communication with the data acquisition board may be configured to execute a first logic stored in a first memory that causes the processor to receive the data from each sensor within a project area defined by a predetermined distance from a predefined reference point, and use the asset identification information to generate an onsite asset list, format the received data, and transfer the received data to at least one of a database server, a local data center, a local personal device, a remote personal device or a display device. A personal device may be any type of computing device, including mobile devices, whereas a mobile personal device may be a smartphone, tablet computer, or similar technology.

Another embodiment of the present invention is a system and method for communicating between assets associated with a construction site and a database server remote from the construction site. A data acquisition board is disposed on the construction site. A plurality of sensors are associated with the assets on the construction site, and each sensor transmits data associated with its respective asset to the data acquisition board. The data comprises an operating parameter of the asset and asset identification information for the operating parameter. A processor in communication with data acquisition board is configured for executing a first logic that causes the processor to receive the data from each sensor in a first predetermined list of assets, format the received data, and transfer the received data to the database server remote from the construction site. The data may also be transferred to one or more of a local data center, a local personal device, a remote personal device, or a remote display device.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a block diagram of an exemplary system and method for communicating between assets associated with a construction site according to one embodiment of the present invention;

FIG. 2 is a block diagram of an exemplary data acquisition board configuration;

FIG. 3 is a block diagram of an exemplary alternative embodiment of a data acquisition board;

FIG. 4 is a screenshot of an exemplary graphical user interface depicting a Project List display;

FIG. 5 is a screenshot of an exemplary graphical user interface depicting an Asset List display;

FIG. 6 is a screenshot of an exemplary graphical user interface depicting a Historical List display;

FIG. 7 is a flow chart of an exemplary Logic Algorithm; and

FIG. 8 is an exemplary GUI depicting output from the exemplary Logic Algorithm.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used in the claims, the definite article “said” identifies required elements that define the scope of embodiments of the claimed invention, whereas the definite article “the” merely identifies environmental elements that provide context for embodiments of the claimed invention that are not intended to be a limitation of any claim. As used herein, the terms “first,” “second,” and “third” may be used interchangeably to distinguish one component from another and are not intended to signify location or importance of the individual components.

For the purposes of this document, the development footprint of a construction site includes any land used for buildings, hardstanding, landscaping, site access or where construction work is carried out (or land being disturbed in any other way). It also includes any areas used for temporary site storage and buildings.

Various embodiments of the present invention provide a system and method for communicating with assets associated with a construction site. The system generally includes one or more sensors associated with the equipment on the asset in wired or wireless communications with a data acquisition board disposed on the construction site. The sensor data may include an operating parameter of the asset which may include, for example, temperature, pressure, speed, depth, weight, volume, or other operating parameters for various equipment on the construction site. The sensor data may also include unique identification information for the asset, location information that defines or can be used to define the location of the asset, a timestamp, weather conditions, weather forecasts, location of the construction site, and/or attitude (e.g., pitch and yaw) of the construction site.

The system establishes a predefined reference point on the construction site. The data acquisition board may include a processor configured to execute a first logic stored in a first memory that causes the processor to receive data from each sensor within a project area defined by a predetermined distance from the predefined reference point. Alternatively, the first logic may cause the processor to receive data from each sensor included in a first predetermined list of the assets and within the project area. Notably, the processor may be located on the construction site or off the construction site such as on the remote database server.

The first logic further causes the processor to format the received data and transfer the formatted or unformatted received data to a remote database server. Periodically (at random, unequal or equal intervals), continuously, or upon request, the data acquisition board may further transfer and/or synchronize the received data with a personal communications device such as a smartphone or a tablet, and the personal communications device may further transmit the data to a database server remote from the construction site. Alternatively, or in addition, the data acquisition board may transmit the received data directly to the database server. The database server allows a data user to access the data.

The processor and/or database server may be configured to use the data to generate an onsite asset list which represents equipment within the predetermined project area. The processor may further receive offsite data from assets outside the predetermined project area but within the communication range of the processor. The processor may be configured to receive and format the offsite data and transmit the formatted or unformatted offsite data to the database server. The processor and/or database server may be further configured to use the offsite data to generate an offsite asset list or to cause a local or remote device to generate a graphical user interface that presents the information in any suitable format desired by a user.

The processor and/or the database server may be further configured to receive project type information from each other or one of a local personal device or a remote personal device. Project type information is information describing the type of work project that may be scheduled to occur in the future. For this embodiment, the processor and/or database server may be configured to execute a logic that causes the processor and/or database server to use the project type information to access a historical asset list stored in a memory for the project type. One example of a historical asset list is a list of assets that have been needed in the past for a particular project. The historical asset list may be based on experience, and it may be manually or automatically created over time by an algorithm executed by the processor and/or database server. The processor and/or database server may compare the onsite asset list with the historical asset list and generate a missing asset list if there is an asset listed in the historical asset list that is not listed in the onsite asset list.

The historical asset list may also be a list of assets previously determined to be in a predetermined area such as a project area. Such a historical asset list would be useful to detect borrowed or stolen property. Other types of lists may be generated as well using historical information.

In this manner, the systems and methods described herein may enable a user to remotely communicate with the construction site to receive real-time or near real-time data from the construction site regarding the assets associated with the construction site, group assets based on their location or some other criteria, and allocate the assets for future projects as well as monitor the assets during a project.

The present disclosure refers to sensors, processors, database servers, logic, memory, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, methods discussed herein may be implemented using a single server or multiple servers working in combination. Similarly, databases and logic for manipulating the databases may be implemented on a single system or distributed across multiple systems sequentially or in parallel. Data transferred between components may travel directly or indirectly. For example, if a first device accesses a file or data from a second device, the access may involve one or more intermediary devices, proxies, and the like. The actual file or data may move between the components, or one device may provide a pointer or metafile that the other device uses to access the actual data from a still further device.

The various computer systems discussed herein are not limited to any particular hardware architecture or configuration. Embodiments of the methods and systems set forth herein may be implemented by one or more general-purpose or customized computing devices adapted in any suitable manner to provide the desired functionality. The device(s) may be adapted to provide additional functionality complementary or unrelated to the present subject matter, as well. For instance, one or more computing devices may be adapted to provide desired functionality by accessing logic or software instructions rendered in a computer-readable form. When software is used, any suitable programming, scripting, or other type of language or combinations of languages may be used to implement the teachings contained herein. However, software need not be used exclusively, or at all. For example, some embodiments of the systems and methods set forth herein may also be implemented by hard-wired logic or other circuitry, including, but not limited to application-specific circuits. Of course, combinations of computer-executed software and hard-wired logic or other circuitry may be suitable, as well.

Embodiments of the systems and methods disclosed herein may be executed by one or more suitable computing devices. Such system(s) may include one or more computing devices adapted to perform one or more embodiments of the methods disclosed herein. As noted above, such devices may access one or more computer-readable media that embody computer-readable instructions which, when executed by at least one computer, cause the computer(s) to implement one or more embodiments of the methods of the present subject matter. Additionally, or alternatively, the computing device(s) may include circuitry that renders the device(s) operative to implement one or more of the methods of the present subject matter. Furthermore, components of the presently disclosed technology may be implemented using one or more computer-readable media. Any suitable computer-readable medium or media may be used to implement or practice the presently-disclosed subject matter, including, but not limited to, diskettes, drives, and other magnetic-based storage media, optical storage media, including disks (including CD-ROMs, DVD-ROMs, and variants thereof), flash, RAM, ROM, and other memory devices, and the like.

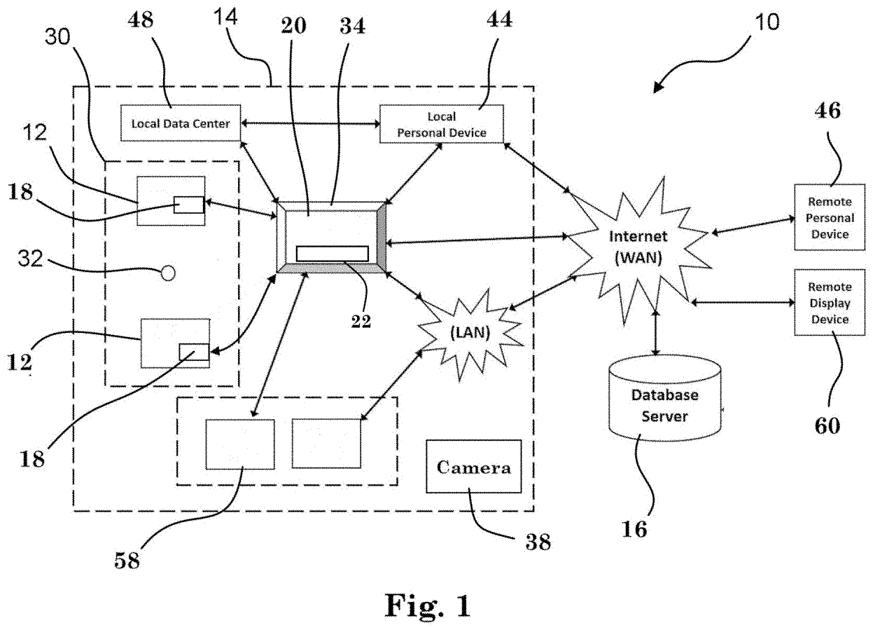

Referring now to the drawings, wherein identical numerals indicate the same elements throughout the figures, FIG. 1 provides a block diagram of an exemplary system and method 10 for communicating between assets 12 associated with a construction site 14 and a database server 16 remote from the construction site 14 according to one embodiment of the present invention. The system 10 may include a plurality of sensors 18 on the construction site 14, wherein each sensor 18 transmits data associated with its respective asset 12 to a data acquisition board 20, wherein the data includes an operating parameter of the asset 12 as well as identification information for the asset 12. For example, if there are ten pieces of heavy equipment on a construction site, at least one sensor would preferably be associated with each piece of heavy equipment and each sensor 18 would transmit an operating parameter and identification information associated with its respective piece of heavy equipment to the data acquisition board 20. The system 10 includes a predefined reference point 32 on the construction site which may be defined by a data acquisition board 20.

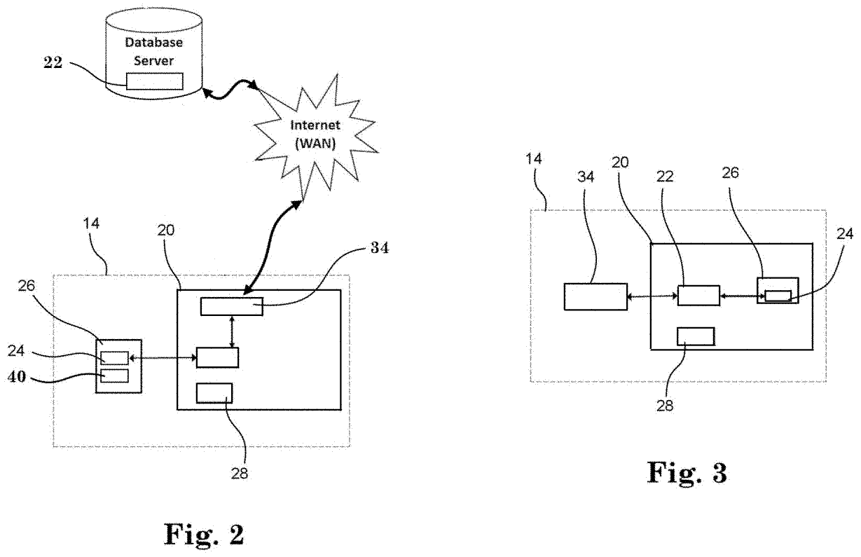

A processor 22 in communication with the data acquisition board 20 is configured to execute a first logic 24 stored in a first memory 26 (FIG. 2 and FIG. 3). The first memory 26 may be memory onboard processor 22 or a memory electrically associated with processor 22. A communications link between the processor 22 and remote database server 16 may include one or more wired, wireless, or other suitable communication links known to one of ordinary skill in the art for transferring data between components.

The data acquisition board 20 may be contained within a protective housing on the construction site 14 to insulate the data acquisition board 20 from the environment. The degree and type of protection the housing provides are dictated by the environment in which the data acquisition board 20 is used (e.g., weatherproof, hermetically sealed, etc.). The data acquisition board 20 and associated components may be powered by an onboard power source 28 or an external power source (not shown). For example, an external power source associated with the asset 12 may power the data acquisition board 20 when the asset is operating, and the onboard power source 28 may power the data acquisition board 20 when the external power source is not supplying power. The data acquisition board 20 may be on an asset or associated with a support structure and placed at a predefined reference point 32 or another location on the construction site 14.

The first logic 24 may cause the processor 22 to receive data from each sensor 18 within a project area 30 defined by a predetermined distance from the predefined reference point 32, format the received data, and transfer the received data to the database server 16. The data may be transmitted to the database server 16 in unformatted or formatted form. The processor 22 may be electrically associated with communication technology 34 to transmit the data to other devices.

The project area 30 may take any shape. Where the project area 30 is a circle, the predetermined distance may be the radius of the circle. Such a configuration is particularly useful when the data acquisition board 20 is located at or near the predefined reference point 32. That said, as depicted in FIG. 1, it is not required for the data acquisition board 20 to be located at or near the predefined reference point 32. Similarly, when the project area 30 is a rectangle, for example, the predetermined distance may be a first distance (e.g., length) and a second distance (e.g., width) from the predefined reference point 32 (although a square would only need one distance parameter). Thus, the parameter defining the predetermined distance from the predefined reference point 32 may be a single distance parameter or multiple distance parameters as needed to define the shape of the project area 30.

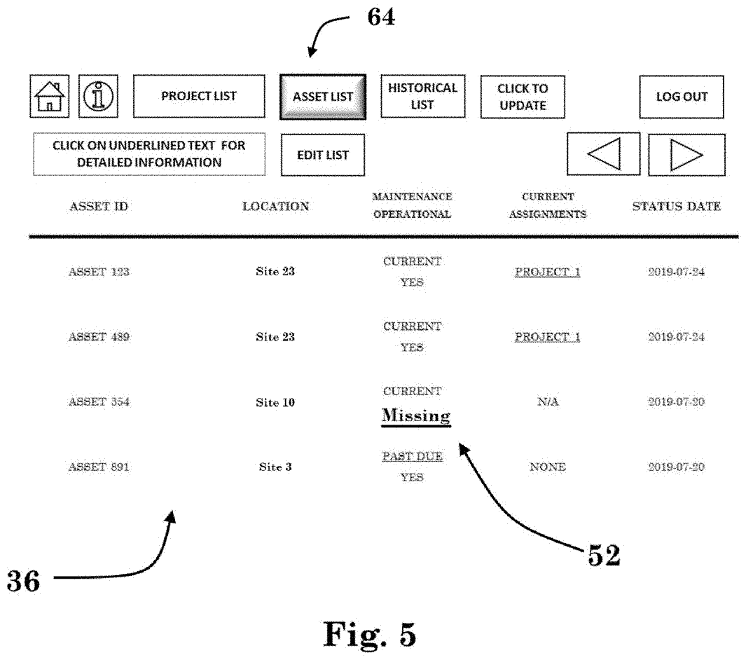

As noted above, the data from the sensors 18 may include asset identification information and/or asset location information that can be used to identify the asset 12, and the location of the asset 12. The processor 22 and/or the database server 16 may be configured to use such data to generate a list of assets detected within the project area 30 thereby defining an onsite asset list 36 (FIG. 5). Note that the exemplary GUI in FIG. 5 presents/mixes several lists in its display.

As shown in FIG. 1, the system may further include a camera 38, and the processor 22 may be further configured to execute a second logic 40 stored in the first memory 26 that causes the processor 22 to activate the camera 38 to obtain a visual image of the asset within said predetermined distance (e.g., project area 30). Alternatively, the processor 22 may use a mobile camera 38 to take images of the last known location of an asset 12 which is particularly useful to look for missing assets. Such a camera 38 may be associated with mobile technology such as drone technology. Drone technology is well known by those of ordinary skill in the art, and a description thereof is not provided.

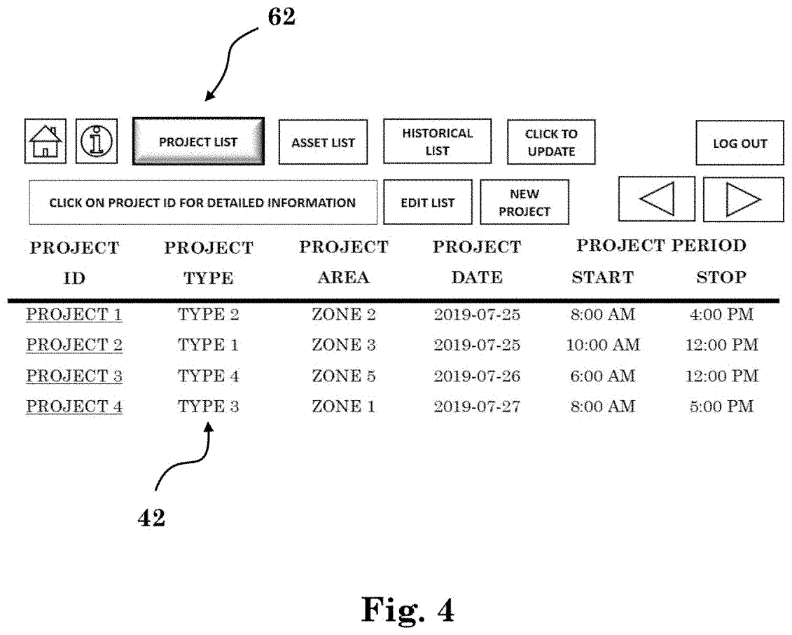

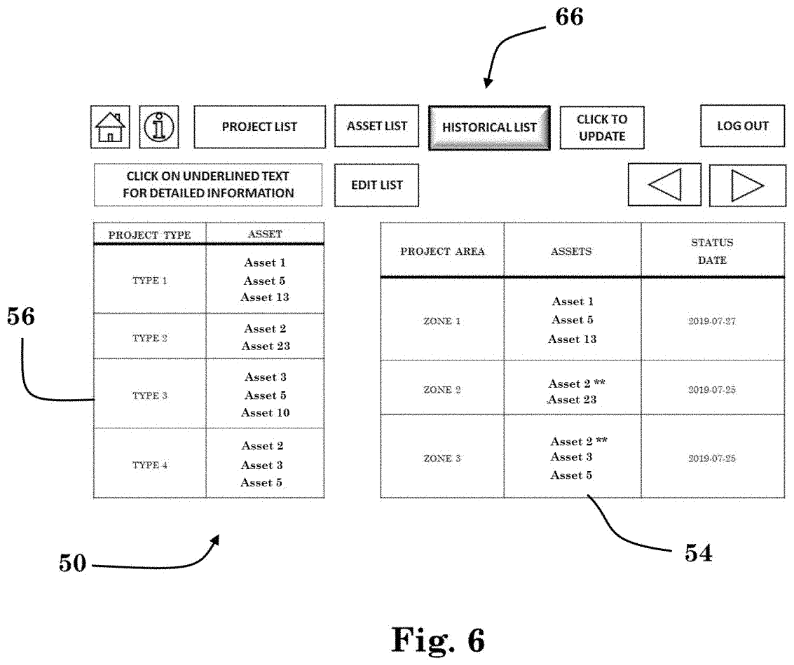

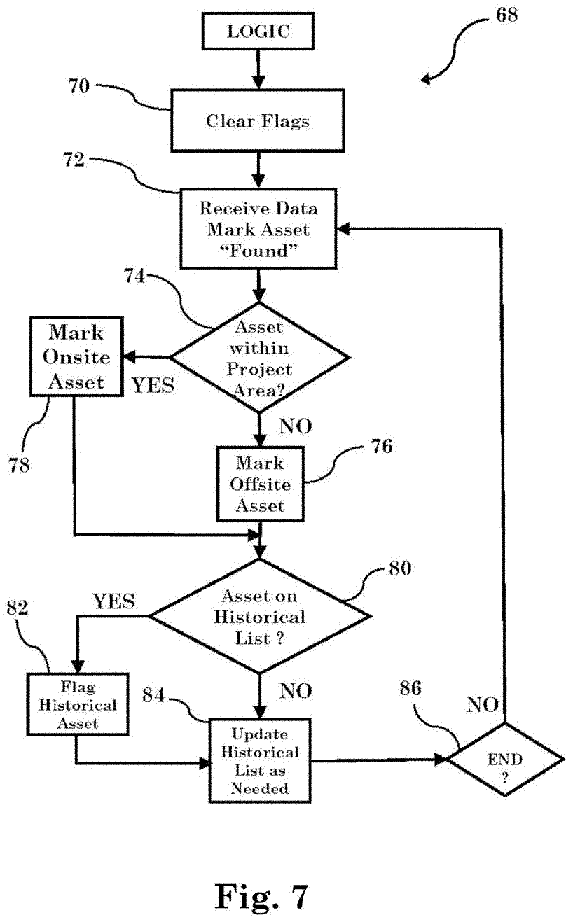

The processor 22 or database server 16 may be further configured to receive project type information 42 (FIG. 4, FIG. 6) from the data acquisition board 20 or any one of a local personal device 44, a remote personal device 46, or a local data center 48 (FIG. 1). The processor 22 or database server 16 may be configured to use the project type information 42 and a historical asset list 50 (FIG. 6) stored in a memory and compare the onsite asset list 36 with the appropriate historical asset list 50 for the project type to generate a missing asset list 52.

The historical asset list 50 may be a list of onsite assets 54 (FIG. 6) that were previously detected in a project area 30. Alternately, the historical asset list 50 may be a list of required assets 56 that experience indicates are required for a particular project type 30. Such historical asset lists may be manually or automatically created or updated as new information becomes available.

The first logic 24 may further cause the processor 22 to receive data from sensors outside the project area 30, where such data represents offsite assets 58. The processor 22 may format the received data, tag such data as offsite data, generate an offsite asset list, and transfer the offsite data or the offsite asset list to a device such as the database server 16, a local data center 48, a local personal device 44, or a remote personal device 46. At least one of the processor 22 or database server 16 may be configured to compare the offsite asset list to the missing asset list 52 and generate notifications based on such comparisons. For example, a notification may be generated for the assets determined to be on both the offsite asset list 54 and the missing asset list 52. One of ordinary skill in the art will appreciate that such notification would allow the automatic or manual asset reallocation to meet a current or future need.

For one embodiment, the data acquisition board 20 may be connected to a control module associated with the asset 12. A predefined operational area is established for the asset 12. The processor 22 executes a second logic that disables the asset 12 when it travels outside the predefined operational area. Preferably, before disabling the asset 12, a warning will be issued, and the processor 22 will wait a predefined delay period before disabling the asset 12. If the asset 12 returns to the predefined operational area or an override signal is received, the processor 22 will not disable the asset.

As depicted in FIG. 6, the processor 22 may further cause a GUI 66 to identify when an asset 12 is scheduled to be in two places on the same day. In FIG. 6, a double “*” is used to identify a conflict. Such will allow a user to verify such is possible and desired and to take corrective action as needed.

One alternative embodiment of the system 10 for communicating between assets 12 associated with the construction site 14 and the database server 16 remote from the construction site 14 includes the data acquisition board 20, sensors 18, and processor 22, as previously described. The processor 22 may be configured to execute the first logic 24 stored in the first memory 26 that causes the processor 22 to receive the data from each sensor 18 included in a first predetermined list of assets 12, format the received data, and transfer the received data to the database server 16 remote from the construction site 14. Any predetermined list may be used, such as the onsite asset list 36, the offsite asset list, a needed asset list, the list of equipment within the project area 30, or the list of missing assets 52.

As further shown in FIG. 4, FIG. 5 and FIG. 6, the various data and lists generated using the sensor data may be transmitted to one or more graphical user interfaces (GUI) for display on a local personal device 44, a remote personal device 46, local display device or a remote display device 60. FIG. 4 presents an exemplary project list, GUI 62 presenting a project list showing project type information 42, and associated data. FIG. 5 presents an exemplary Asset List GUI 64 presenting a list of assets that includes onsite assets, offsite assets, and missing assets. Similarly, FIG. 6 presents a Historical List GUI 66, which presents at least part of the data that is used to determine the missing asset list 52 as well as other lists. The GUIs may be configured for any type of a personal electronic device (mobile or stationary) including smartphones, tablets, computers, or other communication devices selected by a user. Further, a user may select the method (e.g., e-mail, text, dashboard alert, etc.) by which the user may receive data and notifications from the processor 22 or database server 16 or other electronic devices connected to the system 10.

### Logic Algorithm

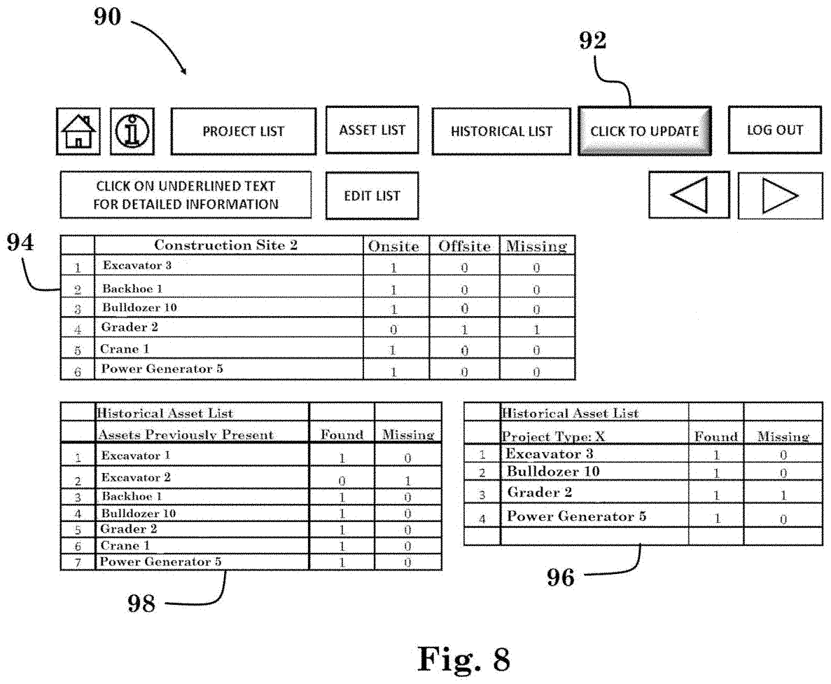

Referring now to FIG. 7, one exemplary logic algorithm 68 for detecting missing assets and updating a historical asset list 50 is presented. Preferably a user manually executes, or an algorithm automatically executes, the logic algorithm 68 when updated information is desired. At block 70, the relevant flags associated with elements of the historical asset list 50 are cleared as needed, and a “Ping” is transmitted. A “ping” is simply an “anybody out there” signal requesting assets to respond. For this example, all assets that respond are associated with a “found flag.” If the “found flag’ is set, the asset's location is known. One of ordinary skill in the art will appreciate that many flagging methods can be used. At block 72, the processor 22 receives data from a sensor 18 (or multiple sensors, but this example will focus on one sensor response), and the associated asset is marked “Found.” At block 74, the processor 22 determines if the asset associated with the sensor 18 data is within a predefined project area 30 (e.g., defined by a predetermined distance from the reference point 32 on the construction site 14). If no, at block 76, the asset is tagged as an offsite asset 58, and program control is passed to block 80, and the processor 22 determines if the asset is listed on a historical asset list. If yes, the asset is marked “Missing,” and program control passes to block 82 (here, “missing” means missing from the project area 30). If no at block 80, program control passes to block 84 where the historical asset list is updated as needed.

If yes, at block 74, program control passes to block 78, and the asset is tagged as an onsite asset 54, and program control is passed to block 80. At block 80, the asset is compared to a historical assets list 50. If the asset is on the historical asset list, the asset is marked as a historical asset at block 82, and program control passes to block 84. If the asset is not on the historical asset list 50, program control passes directly to block 84 where the historical asset list 50 is updated as needed.

Notably, if an “onsite” asset is found on the historical list for the assets needed for a project type (for example), such would be expected and no additional action may be needed other than updating a GUI. In contrast, if an “onsite” asset is not found on the historical asset list, an historical asset list update action may be needed. One possible updated action is to add a new asset to the historical asset list. Similarly, if an “offsite” asset is found in the historical asset list, such asset is “missing” from the project area (though its location is known) and may be misallocated and need to be reassigned.

After the historical asset list is updated as needed at block 84, program control passes to block 86 where the algorithm determines if it should end execution or look for more data and run the algorithm again.

By way of example, FIG. 8 shows an exemplary GUI 90 for generating and updating lists. A user manually updates 92, or an algorithm executes the logic algorithm 68 which asks: “Is there anybody out there?” (i.e., generates a ping). Assets 94 that receive the message respond and the logic algorithm 68 determines: (1) Excavator 3, (2) Backhoe 1, (3) Bulldozer 10, (4) Grader 2, (5) Crane 1, and (6) Power Generator 5 are located at the construction site. All such assets are “Found” to be “Onsite” assets but for Grader 2 which is “Found” to be an “Offsite” asset. A predetermined Historical Asset List 96 has been selected for a Type X activity comprising assets: Excavator 3, Bulldozer 10, Grader 2, and Power Generator 5. The logic algorithm determines the Grader 2 is “Missing” which in this case means the asset is not in the Project Area X but its location is known. A user may then reallocate the Grader 2 asset for the upcoming Project X activity.

The algorithm may further access a Historical Asset List for Assets Previously Present 98 at the construction site which comprises: Excavator 1, Excavator 2, Backhoe 1, Bulldozer 10, Grader 2, Crane 1, and Power Generator 5. Here, the logic algorithm determines the Excavator 2 is “Missing” because its location is not known (no response from the ping). Such could indicate theft or misallocation. A mobile or stationary camera might then be accessed to take an image of the asset's last known location. If the asset is where it should be such would be a good indication of technical problems with the system.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims

What is claimed is:

1. A system for communicating between assets associated with a construction site and a database server remote from the construction site, the system comprising:
a data acquisition board on the construction site;
a plurality of sensors each associated with an asset on the construction site, wherein each sensor transmits data associated with its respective asset to said data acquisition board, wherein said data comprises asset identification information and an operating parameter of the asset on the construction site;
a predefined reference point on the construction site;
a processor in communication with said data acquisition board and configured to execute a first logic wherein said first logic is stored in a first memory;
wherein said first logic causes said processor to receive said data from each sensor within a project area defined by a predetermined distance from said predefined reference point, format said received data, use the asset identification information to generate an onsite asset list and transfer said received data and said onsite asset list to the database server remote from the construction site.

2. The system as in claim 1, further comprising a camera, and wherein said processor is further configured to execute a second logic stored in said first memory that causes said processor to activate said camera to obtain a visual image of the asset within said predetermined distance.

3. The system as in claim 1, wherein the database server generates and transmits project type information to said processor and wherein said processor is further configured to execute a second logic stored in said first memory that causes said processor to access a historical asset list stored in said first memory and compare said onsite asset list with said historical asset list to generate a missing asset list.

4. The system as in claim 3, wherein said historical asset list defines a list of assets previously determined to be within said project area.

5. The system as in claim 3, wherein said historical asset list defines a list of assets historically required for a particular project type.

6. The system as in claim 3, wherein said first logic further causes said processor to receive said data from each sensor outside of said project area, format said received data, tag said data as offsite data, generate an offsite asset list, and transfer at least one of said offsite data or said offsite asset list to the database server.

7. The system as in claim 6, wherein said first logic further causes said processor to compare said offsite asset list to said missing asset list and generate a notification for each asset on both said offsite asset list and said missing asset list.

8. The system of claim 1, wherein said data acquisition board is connected to a control module associated with the asset and wherein the asset has a predefined operational area and wherein said processor executes a second logic that disables the asset when it is outside said predefined operational area after a predefined delay period when said processor does not receive an override signal during the predefined delay period.

9. A system for communicating between assets associated with a construction site and a database server remote from the construction site, the system comprising:
a data acquisition board on the construction site;
a plurality of sensors on the construction site, wherein each sensor transmits data associated with its respective asset to said data acquisition board, wherein said data comprises an operating parameter of the asset and asset identification information for said operating parameter;
a processor in communication with said data acquisition board configured to execute a first logic stored in a first memory;
wherein said first logic causes said processor to receive said data from each sensor included in a first predetermined list of assets, format said received data, and transfer said received data to the database server remote from the construction site.

10. The system as in claim 9, wherein said processor is further configured to communicate with said remote server to determine a predefined project area and wherein said data further comprises location information for the asset and wherein said processor is further configured to generate an onsite asset list for assets found to be within said predefined project area.

11. The system as in claim 10, wherein said first predetermined list is a historical list of assets previously determined to be within said predefined project area and wherein in a second logic in said first memory causes said processor to generate a missing asset list comprising a list of assets on said historical list and not within said predefined project area.

12. The system as in claim 11, further comprising a camera system, and wherein said processor is further configured to execute a third logic stored in said first memory that causes said processor to activate said camera system to obtain a visual image of the last known location of an asset on said missing asset list.

13. The system as in claim 10, wherein a third logic in said first memory causes said processor to receive said data from sensors outside of said predefined project area, format said received data, tag said data as offsite data, generate an offsite asset list, and transfer said offsite asset list to the database server.

14. The system as in claim 13, wherein a fourth logic causes the processor to access location information defining the operational area for an asset and disable an asset when the asset travels beyond said operational area after a predefined delay period.

15. The system as in claim 14, wherein said processor does not disable the asset when an abort signal is received during said predefined delay period.
